(19) United States
(12) Patent Application Publication
(10) Pub. No.: US 2012/0198065 A1
(43) Pub. Date: Aug. 2, 2012

(54) Method of Accessing a Cloud Service and Related Device

(76) Inventor: Chih-Hsing Sung, Taipei City (TW)

(21) Appl. No.: 13/018,439

(22) Filed: Feb. 1, 2011

(51) Int. Cl. G06F 15/173

(52) U.S. Cl. 709/225

(57) ABSTRACT

A cloud service is accessed by an access module. The access module receives a simple control code from an electronic device that is electrically connected to the access module, and the access module utilizes high-level protocols and software stacks to send/receive data to/from the cloud service according to the simple control code.

### BACKGROUND OF THE INVENTION

1. Field of the Invention

The present invention relates to access devices, and more particularly, to a method and related access device that allow a simple-processor-based device to access cloud services.

2. Description of the Prior Art

Development of Internet technologies, such as cloud computing, has outpaced many legacy devices that continue to run on very low complexity processors. Whereas personal computers commonly utilize 64-bit processors, and even smartphones include 32-bit processors, a large number of devices, such as point-of-sale (POS) terminals, multimedia players, digital cameras, and personal navigation devices still use relatively simple processors, e.g. 8-bit microcontroller units (MCUs). While cloud computing offers storage of data on a large server grid, which reduces capital costs for businesses and individuals, lowering risk, and increasing availability of the data, most cloud computing services require high-level web protocols to run. Examples of said high-level web protocols include Hypertext Transfer Protocol (HTTP), Hypertext Transfer Protocol Secure (HTTPS), Representational State Transfer (REST), Simple Object Access Protocol (SOAP), Extensible Markup Language-Remote Procedure Call (XML-RPC), and Software as a service (SaaS). Software stacks are also required for structured data processing, security, and authentication. Much physical, real-time, useful data is generated by devices that employ simple processors. Unfortunately, it is hard to program such protocols and software stacks onto simple processors, not to mention the simple processors are not powerful enough to run the high-level web protocols and software stacks required to access cloud services.

### SUMMARY OF THE INVENTION

According to one embodiment, a method of accessing a cloud service comprises an access module receiving a simple control code from an electronic device electrically connected to the access module, and the access module utilizing high-level protocols and software stacks to access the cloud service according to the simple control code.

According to an embodiment, an access module comprises a network transmitter, and a processor for receiving a simple control code from an electronic device electrically connected to the access module, and utilizing high-level protocols and software stacks to access a cloud service according to the simple control code.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a networked device according to an embodiment.

FIG. 2 is a flowchart of a process for accessing a cloud service according to an embodiment.

FIG. 3 is a diagram of a process utilized in the access module for interacting with the electronic device based on access to the cloud service.

### DETAILED DESCRIPTION

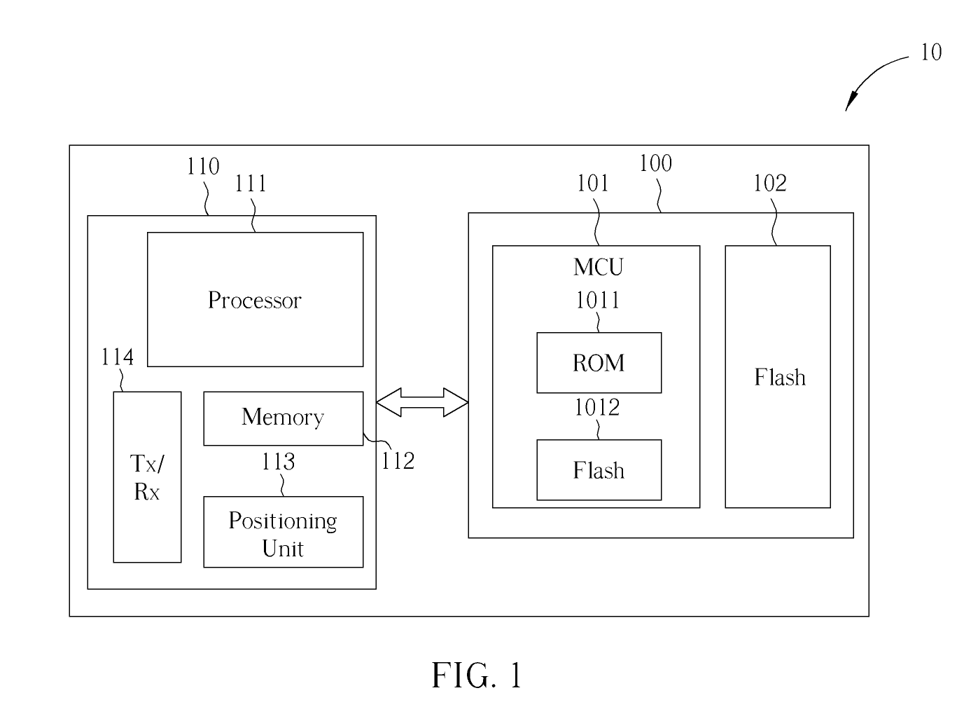

Please refer to FIG. 1, which is a diagram of a networked device 10 according to an embodiment. The networked device 10 includes a simple-processor-based electronic device 100 (or “electronic device 100”) and an access module 110. The electronic device 100 is electrically connected to the access module 110 through a data bus 120 for transmitting simple control codes to the access module 110. The electronic device 100 accesses a web-based service, such as a cloud service, through the access module 110 according to the simple control codes.

The electronic device 100 may comprise a microcontroller unit (MCU) 101. The MCU 101 may include read-only memory (ROM) 1011 and flash memory 1012, without limitation thereto. The electronic device 100 may further comprise a flash memory 102. The MCU 101 may send and receive simple control codes, such as AT commands (attention commands), to and from the access module 110 through the data bus 120. The electronic device 100 may be a point-of-sale (POS) terminal, security camera, credit card reader, personal navigation device, digital camera, multimedia player, digital watch, or other electronic device based on a simple processor such as the MCU 101. The simple control codes are preferably AT commands, but may be proprietary control codes in another embodiment.

The access module 110 comprises a complex processor 111, memory 112, and a transceiver 114, and may also comprise a positioning module 113. The complex processor 111 is electrically connected to the data bus 120 for receiving and sending AT commands from and to the MCU 101 of the electronic device 100, and is capable of interpreting the AT commands to perform certain actions. The access module 110 has wider instruction width and/or data bus width than the electronic device 100. In a preferred embodiment, the MCU 101 of the electronic device 100 is an 8-bit MCU, and the complex processor 111 of the access module 110 is a 32-bit or higher processor. The access module 110 may be a Machine-to-Machine (M2M) module, a 3G wireless Universal Serial Bus (USB) dongle, or other wireless module based on a higher-end processor, such as the complex processor 111. The access module 110 may be connected to the electronic device 100 through an appropriate connector, e.g. a USB connector or RS-232 serial line. The access module 110 may also be an integrated circuit packaged in a chip, and may be electrically connected to the electronic device 100 over a printed circuit board (PCB).

The transceiver 114 may be utilized for establishing a network connection. Examples of the transceiver 114 include, but are not limited to, wireless transceivers, such as an IEEE 802.11b/g/n or other so-called “Wi-Fi” transceivers, a WiMAX transceiver (IEEE 802.16), a Global System for Mobile (GSM) transceiver (including EDGE), a 3G transceiver (including at least 3.5G and 3.75G), and/or a 4G transceiver. The transceiver 114 may also be a wired transceiver based on IEEE 802.3 (Ethernet) or another wired networking standard.

The access module 110 may further comprise data processing circuits, such as audio encoders/decoders, video encoders/decoders, image processing circuits, and digital signal processing circuits.

In one configuration, the electronic device 100 accesses Latitude™ by Google of Mountain View, Calif. Latitude™ is a tracking service based on Google Maps™, which is available as a web service. Latitude™ is accessed via REST, and responds in JSON (JavaScript Object Notation). Latitude™ requires a complicated authentication process over a secure connection, as well as GoogleApps™ registration. To add a tracking feature to the electronic device 100, such as an MP3 player, the access module 110 includes the transceiver 114 and the positioning module 113, e.g. a Global Positioning System (GPS) module. A conventional method of connecting the MP3 player to any web-based positioning service would include defining a proprietary protocol between the MP3 player and the server, and implementing a proprietary positioning server. However, in one embodiment, the high-level protocols and software stacks may be built onto the MCU 101 of the MP3 player for accessing Latitude™. In a preferred embodiment, the high-level protocols and software stacks are built onto the complex processor 111 of the access module 110, and the MCU 101 accesses Latitude™ by sending simple AT commands to the access module 110, which interacts with Latitude™ according to the simple AT commands.

In another configuration, the electronic device 100 accesses Goggles™ by Google of Mountain View, Calif. The electronic device 100 may be a digital camera, and the access module 110 may include the transceiver 114. The digital camera may then access Goggles™ by sending simple AT commands to the access module 110, which interacts with Goggles™ according to the simple AT commands.

In another configuration, the electronic device 100 accesses online services provided by Amazon Web Services, LLC (AWS), an Amazon.com company, such as CloudFront™, SimpleDB™, and/or Elastic Compute Cloud™ (EC2). For example, SimpleDB™ provides a paid relational database in the cloud, which is accessible as a web service, and fully compatible with MySQL. SimpleDB™ may be utilized for metering, monitoring, tracking, auditing, real-time data analysis, archival, and/or regulatory compliance. The electronic device 100 may access SimpleDB™ by sending simple AT commands to the access module 110, which interacts with SimpleDB™ according to the simple AT commands.

In another configuration, the electronic device 100 accesses YQL™ (Yahoo! Query Language) by Yahoo! Inc. YQL™ is an SQL-like language that allows querying, filtering, and data linking across different web services. The electronic device 100 may access YQL™ by sending simple AT commands to the access module 110, which interacts with YQL™ according to the simple AT commands.

Other web-based services, including location-based services, relational databases, image recognition services, social networks, and/or storage services, which may include Facebook™, Flickr™, Picasa™, Twitter™, any of the services described in the examples above, or other similar web-based services, may also be accessed by the electronic device 100 through simple AT commands via the access module 110. The access module 110 may include such high-level protocols as HTTP/HTTPS, REST, SOAP, XML-RPC, SaaS, JSON, and X.509 authentication. The access module 110 may perform operations such as secure connection, authentication, URL (Universal Resource Locator) encoding, XML/JSON data processing, registration for web-based applications, login/logout, payment, and/or data storage. The access module 110 may upload data, such as real-time status, location, images, text, audio, and/or video to the web-based services.

The electronic device 100 may be preloaded with AT commands used to indicate which cloud service is to be accessed by the access module 110. The access module 110 may be preloaded with a cloud-service-specific implementation that allows the access module 110 to interact with the cloud service. The cloud-service-specific implementation may be a plurality of program codes utilizing the Application Programming Interface (API] provided by the cloud service provider. Thus, the access module 110 is able to interpret the AT command received from the electronic device 100, and access the corresponding cloud service using the cloud-service-specific implementation loaded in the access module 110.

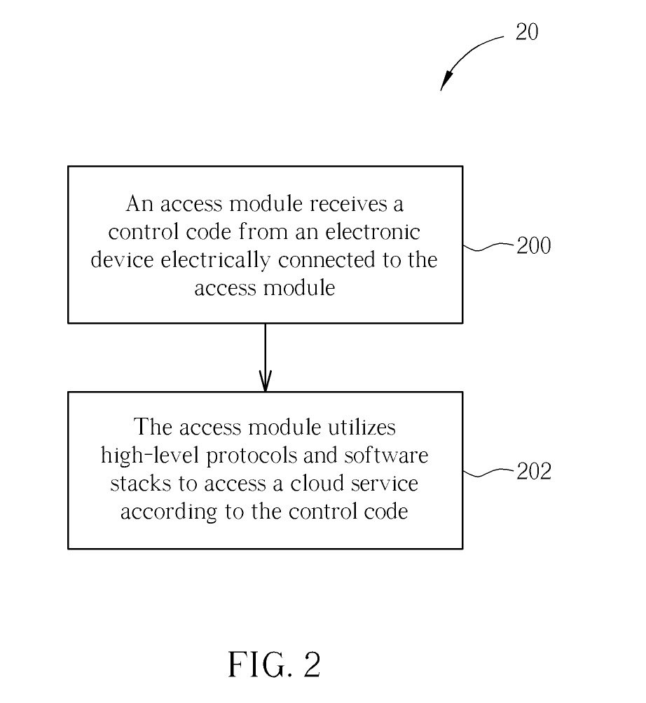

Please refer to FIG. 2, which is a flowchart of a process 20 for accessing a cloud service according to an embodiment. The process 20 may be performed by the access module 110, and comprises the following steps:

Step 200: An access module receives a control code from an electronic device electrically connected to the access module; and

Step 202: The access module utilizes high-level protocols and software stacks to access a cloud service according to the simple control code.

In the process 20, the electronic device 100 and/or the access module 110 may generate data, such as measurement data, input data, statistical data, and/or operating data, without limitation thereto. For example, data generated by the electronic device 100 may include sales data for a POS terminal. Data generated by the access module 110 may include position data, such as geographic longitude and latitude determined by the positioning device 113. In some use cases, the access module 110 may not require the simple control code from the electronic device 100 to access the cloud service. For example, the access module 110 may simply send the geographic coordinates of the electronic device 100 periodically to the cloud service, thereby enhancing the electronic device 100 with web tracking. Specifically, the geographic coordinates may be retrieved from the positioning device 113 of the access module 110 through control of the electronic device 100 (e.g. through a program on the MCU 101). Timing to send a request, the user identification, related parameters and conditions are also preferably controlled by the MCU 101. The access module 110 may perform authentication, security, and/or a login operation when accessing the cloud service.

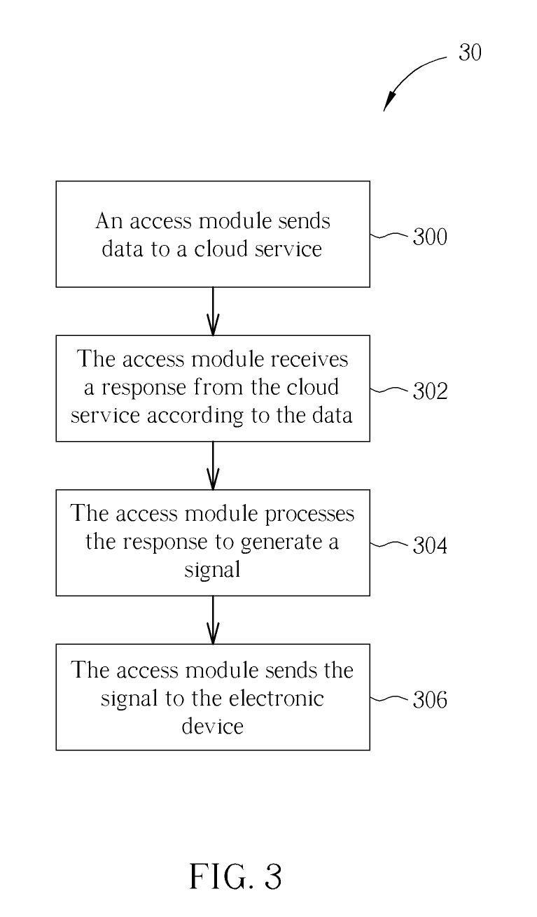

Please refer to FIG. 3, which is a diagram of a process 30 utilized in the access module 110 for interacting with the electronic device 100 based on access to the cloud service. The process 30 comprises the following steps:

Step 300: An access module sends data to a cloud service;

Step 302: The access module receives a response from the cloud service according to the data;

Step 304: The access module processes the response to generate a signal; and

Step 306: The access module sends the signal to the electronic device.

In Steps 300 and 302, the access module may access the cloud service in a number of ways including, but not limited to, sending data to the cloud service, sending a query to the cloud service, receiving a response to the query from the cloud service, and receiving guidance from the cloud service according to environmental data of the access device and/or the electronic device. In Step 304, for example, the access module may process the response to generate a device command according to the guidance received from the cloud service, and the device command may be transmitted from the access device to the electronic device through simple commands (Step 306). The electronic device may receive the device command, and perform a corresponding operation according to the device command. The access module 110 may perform structured data processing, or other such operations when accessing the cloud service. The access module may receive a structural response message in JavaScript Object Notation (JSON) or eXtensible Markup Language (XML) from the cloud service (Step 302). The access module parses the structural response message (Step 304), and the electronic device receives a result of the access module parsing the structural response message sent from the access module in Step 306.

Cloud computing provides data storage and processing at the cost of requiring high-level web protocols to access cloud services. By building the high-level web protocols and related software stacks onto an access module, such as an M2M module or USB dongle, electronic devices that only have simple processors are able to access the cloud through simple AT commands. For the M2M module, the access module is integrated with the electronic device as a whole, whereas for the USB dongle, the access module can be plugged into the electronic device when needed, and the electronic device only needs to integrate a socket for the dongle. The embodiments described above provide many devices that were not originally designed to interact with cloud services, but are capable of generating valuable data, a simple, lightweight solution for integration with the cloud.

Those skilled in the art will readily observe that numerous modifications and alterations of the device and method may be made while retaining the teachings of the invention.

What is claimed is:

1. A method of accessing a cloud service, the method comprising:
an access module receiving a simple control code from an electronic device electrically connected to the access module; and
the access module utilizing high-level protocols and software stacks to access the cloud service according to the simple control code.

2. The method of claim 1, wherein the access module receiving the simple control code from the electronic device is the access module receiving AT commands from the electronic device.

3. The method of claim 1, wherein the access module utilizing the high-level protocols and the software stacks to access the cloud service according to the simple control code is the access module utilizing the high-level protocols and the software stacks to send data generated by the electronic device to the cloud service according to the simple control code.

4. The method of claim 1, wherein the access module utilizing the high-level protocols and the software stacks to access the cloud service according to the simple control code is the access module utilizing the high-level protocols and the software stacks to send data generated by the access module to the cloud service according to the simple control code.

5. The method of claim 1, wherein the access module utilizing the high-level protocols and the software stacks to access the cloud service according to the simple control code comprises:
the access module utilizing the high-level protocols and the software stacks to send a request to the cloud service according to the simple control code; and
the access module utilizing the high-level protocols and the software stacks to receive a response from the cloud service resulting from the request.

6. The method of claim 1, wherein the access module utilizing the high-level protocols and the software stacks to access the cloud service according to the simple control code comprises:
the access module utilizing the high-level protocols and the software stacks to send environmental data of the electronic device to the cloud service according to the simple control code;
the access module receiving a device command from the cloud service corresponding to the environmental data; and
the electronic device performing an operation according to the device command.

7. The method of claim 1, wherein the access module utilizing the high-level protocols and the software stacks to access the cloud service according to the simple control code comprises:
the access module receiving a structural response message in JavaScript Object Notation (JSON) or eXtensible Markup Language (XML) from the cloud service;
the access module utilizing the software stacks to parse the structural response message; and
the electronic device receiving a result of the access module parsing the structural response message.

8. The method of claim 1, further comprising:
the access module performing a login operation on the cloud service prior to accessing the cloud service.

9. The method of claim 1, further comprising:
the access module performing an authentication operation on the cloud service prior to accessing the cloud service.

10. The method of claim 1, further comprising:
the access module performing a security operation on data sent to the cloud service prior to sending the data to the cloud service.

11. The method of claim 1, wherein the access module receiving the simple control code from the electronic device electrically connected to the access module is the access module receiving the simple control code from an electronic device electrically connected to the access module through a serial port.

12. The method of claim 1, wherein the access module receiving the simple control code from the electronic device electrically connected to the access module is the access module receiving the simple control code from an electronic device in which the access module is integrated.

13. An access module comprising:
a network transmitter; and
a processor for receiving a simple control code from an electronic device electrically connected to the access module, and utilizing high-level protocols and software stacks to control the network transmitter to access a cloud service according to the simple control code.

14. The access module of claim 13, wherein the simple control code is an AT command.

15. The access module of claim 13, wherein data is received by the access module from the electronic device, and the access module sends the data to the cloud service.

16. The access module of claim 13, wherein data is generated by the access module, and the access module sends the data to the cloud service.

17. The access module of claim 14, wherein the access module sends a device command to the electronic device according to guidance received from the cloud service corresponding to the data for instructing the electronic device to react according to the data.

18. The access module of claim 13, wherein the access module runs a program which utilizes the Application Programming Interface (API) corresponding to the cloud service according to the simple control code for interacting with the cloud service.

19. The access module of claim 13, further comprising:
a positioning module for determining geographic location of the access module;
wherein the data is the geographic location.
